(19) United States
(12) Patent Application Publication
(10) Pub. No.: US 2021/0389417 A1
(43) Pub. Date: Dec. 16, 2021

(54) METHOD FOR DETERMINING THE VALIDITY OF RADAR MEASURED VALUES IN ORDER TO DETERMINE AN OCCUPANCY STATE OF A PARKING SPACE

(71) Applicant: Robert Bosch GmbH, Stuttgart (DE)

(72) Inventor: Peter Bakucz, Klosterlechfeld (DE)

(21) Appl. No.: 17/283,785

(22) PCT Filed: Oct. 7, 2019
(86) PCT No.: PCT/EP2019/077035

§ 371 Date: Apr. 8, 2021

(30) Foreign Application Priority Data
Oct. 11, 2018 (DE) 10 2018 217 395.8

(51) Int. Cl. G01S 7/295; G01S 13/04; G01S 7/41; G01S 13/931

(52) U.S. Cl. CPC G01S 7/2955; G01S 13/04; G01S 2013/9314; G01S 13/931; G01S 7/41

(57) ABSTRACT

A method for determining the validity of radar measured values in order to determine an occupancy state of a parking space. A device that includes at least one radar sensor and a processing unit, the processing unit being configured to carry out the method. A parking area that includes at least one parking space, the parking space including the device.

The present invention relates to a method for determining the validity of radar measured values in order to determine an occupancy state of a parking space.

An occupancy state of a parking space may typically be ascertained and monitored with the aid of different sensors. One example of a suitable sensor is a radar sensor, in which the occupancy state is deduced based on detected radar measured values. A common problem is that the radar measured values may be falsified, for example by environmental influences on the parking space or by a malfunction of the sensor or a drift of the sensor.

Moreover, the present invention relates to a device that is configured to carry out a method according to the present invention.

Furthermore, the present invention relates to a parking area that includes at least one parking space, the parking space including a device according to the present invention.

### SUMMARY

The present invention relates to a method for determining the validity of radar measured values in order to determine an occupancy state of a parking space. In accordance with an example embodiment of the present invention, the method includes at least the following method steps:
a. detecting radar measured values of multiple radar channels at a predefined point in time with the aid of at least one radar sensor, each radar measured value being made up of a real part and an imaginary part,
b. transforming the radar measured values into a polar coordinate system,
c. determining both a first parameter and a second parameter of the transformed radar measured values with the aid of a linearized least-squares polynomial fit method,
d. determining a variance of the first parameter and second parameter determined in method step c,
e. determining the validity of the radar measured values as a function of the variance.

“Validity” is understood to mean whether the radar measured values may be used with a certain reliability for determining the occupancy state. If the validity is sufficient, it may be assumed that the radar measured values are correct and may be utilized for determining the occupancy state. In contrast, if the validity is insufficient, it is to be deduced that the radar measured values are incorrect due to external influences or a sensor malfunction or a sensor drift, and should be discarded.

“Occupancy state of the parking space” is understood to mean whether the parking space is occupied by a motor vehicle or whether the parking space is vacant.

The radar measured values contain pieces of information concerning the surroundings of the parking space, on the basis of which a determination of the occupancy state may take place.

The radar measured values are typically split into an imaginary part and a real part. These may be subsequently transformed into a polar coordinate system. The radar measured values thus acquire a spiral shape in each case.

A logarithmic spiral is expressed by the following equation:

r=αe^{bθ},

where r is the distance from the origin and θ represents the angle with respect to the abscissa. In addition, a is a first parameter and b is a second parameter. The first and second parameter each define a center of the spiral-shaped, transformed radar measured values in the polar coordinate system, the centers together having a spiral shape. It would also be possible to correspondingly apply a polynomial fit method once again to the first and second parameters and determine a further variance of the further parameters thus obtained, as a function of which the validity of the radar measured values is subsequently determinable. The variance indicates how far apart the centers in the polar coordinate system are from one another.

In accordance with an example embodiment of the present invention, it is advantageous that, based on the determined validity of the radar measured values, it may be deduced whether or not the radar measured values may be meaningfully used for further evaluations. The validity is quickly and easily determined, as the result of which a quick decision regarding the evaluation of the radar measured values may be made.

In one example embodiment of the method according to the present invention, it is provided that the validity of the radar measured values is determined in method step e by comparing the variance to a threshold value, the validity of the radar measured values being regarded as sufficient if the variance is less than the threshold value.

It is advantageous that this represents a simple implementation for determining the validity of the radar measured values.

Conversely, it may be determined that the validity of the radar measured values is regarded as insufficient if the variance is greater than or equal to the threshold value.

In one example embodiment of the method according to the present invention, it is provided that the threshold value is 10.

It is advantageous that this represents a meaningful value which divides the validity of the radar measured values into “sufficient” and “insufficient.”

In one example embodiment of the method according to the present invention, it is provided that after method step e, a method step f runs in which the occupancy state of the parking space is determined as a function of the detected radar measured values.

It is advantageous that based on the validity, it may be deduced whether or not the determined occupancy state of the parking space is correct, or with what likelihood this applies.

In one example embodiment of the method according to the present invention, it is provided that method steps a through d are repeated, in method step a the radar measured values of all channels being detected in each case at different points in time within a predefined time period, and after method step e, a method step g running in which the occupancy state of the parking space is determined as a function of the first parameter.

It is advantageous that this represents a simple option for determining the occupancy state of the parking space.

In one example embodiment of the method according to the present invention, it is provided that the first parameter is compared to a further threshold value in method step g, the parking space being determined as occupied if the first parameter is greater than the further threshold value.

It is advantageous that this represents a simple implementation for determining the occupancy state as a function of the first parameter.

In one example embodiment of the method according to the present invention, it is provided that the further threshold value is 1.

It is advantageous that this represents a meaningful value which may divide the parking spaces into “occupied” and “unoccupied.”

Moreover, the present invention relates to a device that includes at least one radar sensor and a processing unit, the processing unit being configured to carry out a method according to the present invention.

Furthermore, the present invention relates to a parking area that includes at least one parking space, the parking space including a device according to the present invention. A parking area includes at least one parking space. This parking space is accordingly suitable for a motor vehicle being parked. The parking area may, for example, be a conventional parking facility or also a parking garage or a parking zone.

### BRIEF DESCRIPTION OF THE DRAWINGS

FIG. 1 shows one exemplary embodiment of a method according to the present invention.

FIG. 2 shows one exemplary embodiment of a device according to the present invention.

FIG. 3 shows transformed radar measured values illustrated in a polar coordinate diagram.

### DETAILED DESCRIPTION OF EXAMPLE EMBODIMENTS

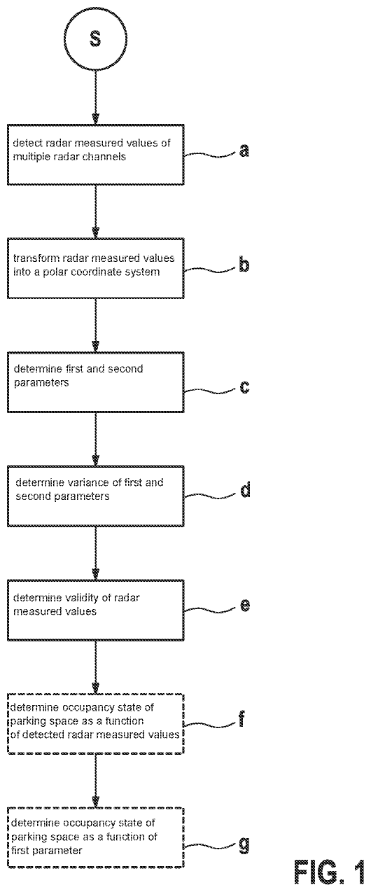

FIG. 1 shows one exemplary embodiment of a method according to the present invention.

Radar measured values 22 of multiple radar channels are initially detected at a predefined point in time with the aid of at least one radar sensor 20 in a method step a, each radar measured value 22 being made up of a real part and an imaginary part. Detected radar measured values 22 are subsequently transformed into a polar coordinate system in a method step b, as the result of which transformed radar measured values 23 are obtained. A first parameter and a second parameter of transformed radar measured values 23 are subsequently determined in each case with the aid of a linearized least-squares polynomial fit method in a method step c. The first parameter and the second parameter each represent the coordinates of the center of transformed radar measured values 23. The first parameter applies in the abscissa direction, and the second parameter applies in the ordinate direction.

A variance of the first parameters and second parameters determined in method step c is subsequently determined in a method step d. The validity of radar measured values 22 is subsequently determined as a function of the variance determined in method step d. The validity of radar measured values 22 may be determined in method step e, for example by comparing the variance to a threshold value, the validity of radar measured values 22 being regarded as sufficient if the variance is less than the threshold value. The threshold value may be 10, for example.

After method step e, a method step f optionally runs in which the occupancy state of the parking space is determined as a function of detected radar measured values 22.

In addition, method steps a through d may optionally be repeated, radar measured values 22 of all radar channels being detected in each case at different points in time within a predefined time period in method step a, and after method step e, a method step g running in which the occupancy state of the parking space is determined as a function of the first parameter. The first parameter may be compared to a further threshold value in method step g, the parking space being determined as occupied if the first parameter is greater than the further threshold value. The further threshold value may be 1, for example.

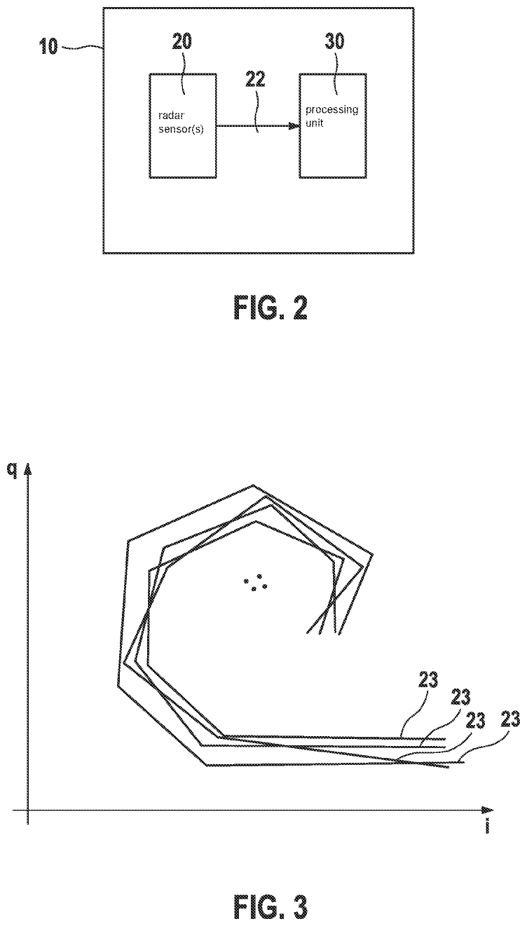

FIG. 2 shows one exemplary embodiment of a device according to the present invention.

A device 10 is illustrated. Device 10 includes a radar sensor 20 and a processing unit 30. Radar sensor 20 is connected to processing unit 30 in such a way that radar measured values that are detected by radar sensor 20 may be tapped by processing unit 30. The connection for this purpose may be hard-wired or also wireless.

Processing unit 30 is designed in such a way that it may carry out a method according to the present invention, for example as illustrated in FIG. 1.

The device may be situated, for example, at a parking space of a parking area, not illustrated, and may monitor the occupancy state of the parking space.

FIG. 3 shows transformed radar measured values illustrated in a polar coordinate diagram.

A polar coordinate system is illustrated. The abscissa represents the real part, and the ordinate represents the imaginary part. Transformed radar measured values 23 are depicted which have been transformed, starting from radar measured values 22 that are detected at a shared point in time. Each of transformed radar measured values 23 includes a center, which is illustrated as a point. This center represents the first parameter as the abscissa value, and the second parameter as the ordinate value.

1-9. (canceled)

10. A method for determining validity of radar measured values to determine an occupancy state of a parking space, comprising the following method steps:
a. detecting radar measured values of multiple radar channels at a predefined point in time using at least one radar sensor, each of the radar measured values being made up of a real part and an imaginary part;
b. transforming the radar measured values into a polar coordinate system;
c. determining both a first parameter and a second parameter of each of the transformed radar measured values using a linearized least-squares polynomial fit method;
d. determining a variance of the first parameters and second parameters determined in step c; and
e. determining the validity of the radar measured values as a function of the variance.

11. The method as recited in claim 10, wherein the validity of the radar measured values is determined in step e by comparing the variance to a threshold value, the validity of the radar measured values being regarded as sufficient when the variance is less than the threshold value.

12. The method as recited in claim 11, wherein the threshold value is 10.

13. The method as recited in claim 10, further comprising the following step:
f. after step e, determining the occupancy state of the parking space as a function of the detected radar measured values.

14. The method as recited in claim 10, wherein steps a through d are repeated, the radar measured values of all channels being detected in each case at different points in time within a predefined time period in step a, and after step e, step g is performed in which the occupancy state of the parking space is determined as a function of the first parameter.

15. The method as recited in claim 14, wherein the first parameter is compared to a further threshold value in step g, the parking space being determined as occupied when the first parameter is greater than the further threshold value.

16. The method as recited in claim 15, wherein the further threshold value is 1.

17. A device, comprising:
at least one radar sensor; and
a processing unit configured to determine validity of radar measured values to determine an occupancy state of a parking space, the processing unit configured to:
a. detect radar measured values of multiple radar channels at a predefined point in time using at least one radar sensor, each of the radar measured values being made up of a real part and an imaginary part;
b. transform the radar measured values into a polar coordinate system;
c. determine both a first parameter and a second parameter of each of the transformed radar measured values using a linearized least-squares polynomial fit method;
d. determine a variance of the first parameters and second parameters determined in c; and
e. determine the validity of the radar measured values as a function of the variance.

18. A parking area, comprising:
at least one parking space, the parking space including a device, including:
at least one radar sensor; and
a processing unit configured to determine validity of radar measured values to determine an occupancy state of the parking space, the processing unit configured to:
a. detect radar measured values of multiple radar channels at a predefined point in time using at least one radar sensor, each of the radar measured values being made up of a real part and an imaginary part;
b. transform the radar measured values into a polar coordinate system;
c. determine both a first parameter and a second parameter of each of the transformed radar measured values using a linearized least-squares polynomial fit method;
d. determine a variance of the first parameters and second parameters determined in c; and
e. determine the validity of the radar measured values as a function of the variance.
